(19) United States
(12) Patent Application Publication
(10) Pub. No.: US 2022/0117045 A1
(43) Pub. Date: Apr. 14, 2022

(54) APPARATUS AND METHOD FOR A HEATING MAT

(71) Applicant: Kjell Lindskog, Skellefteå (SE)

(72) Inventor: Kjell Lindskog, Skellefteå (SE)

(21) Appl. No.: 17/427,457

(22) PCT Filed: Jan. 31, 2020
(86) PCT No.: PCT/SE2020/050082

§ 371 Date: Jul. 30, 2021

(30) Foreign Application Priority Data
Feb. 1, 2019 (SE) 1900015-7

(51) Int. Cl. H05B 3/34

(52) U.S. Cl. CPC H05B 3/345; H05B 2203/016

(57) ABSTRACT

The invention relates to an apparatus for a heating mat (10) comprising two mats (11, 12) of thermoplastic between which mats a heat emitting device (15) is arranged. The device (15) is produced by knitting or crocheting. The invention also relates to methods and uses.

### TECHNICAL FIELD

The present invention relates to an apparatus for a heating mat according to the preamble of claim 1 which has a large number of applications. The invention also relates to a method of manufacturing and uses.

### BACKGROUND OF THE INVENTION

There is a great demand for a formable and flexible heating mat within a number of different areas, such as for heating various objects for a shorter or longer period, for example, for repair work on outdoor details at temperatures below zero, for example, heating roof parts, etc., drainage systems, etc. Also, underfloor heating is possible as well as hospital stretchers, for example, for transportation of persons suffering from hypothermia whereby subdivision in different heating sections can be arranged and so forth. It should be understood that the heating mat according to the invention has a large number of applications in addition to those exemplified above.

### THE OBJECT OF THE INVENTION

The object of the invention is to provide a heating mat which has a very large number of applications.

This object is achieved by the features stated in the claims.

The invention shows both technical and economic advantages.

### SHORT DESCRIPTION OF THE DRAWINGS

Embodiments of the invention will now be described in more detail with reference to the accompanying drawings, in which

FIG. 1 schematically shows an exploded side view of a heating mat according to the invention,

FIG. 2 schematically shows parts of the heating mat according to FIG. 1 in assembled state,

FIG. 3 schematically shows an assembled heating mat in a view from above,

FIG. 4 schematically shows a method for joining together a heating mat according to the invention,

FIG. 5 schematically shows an alternative method for joining together the heating mat,

FIG. 6 schematically shows an alternative embodiment of a heating mat according to the invention in a view from above,

FIG. 7 schematically shows a side view of the heating mat according to FIG. 6, and

FIG. 8 schematically shows a method for joining together the heating mat according to FIGS. 6 and 7.

### DETAILED DESCRIPTION OF SHOWN EMBODIMENTS

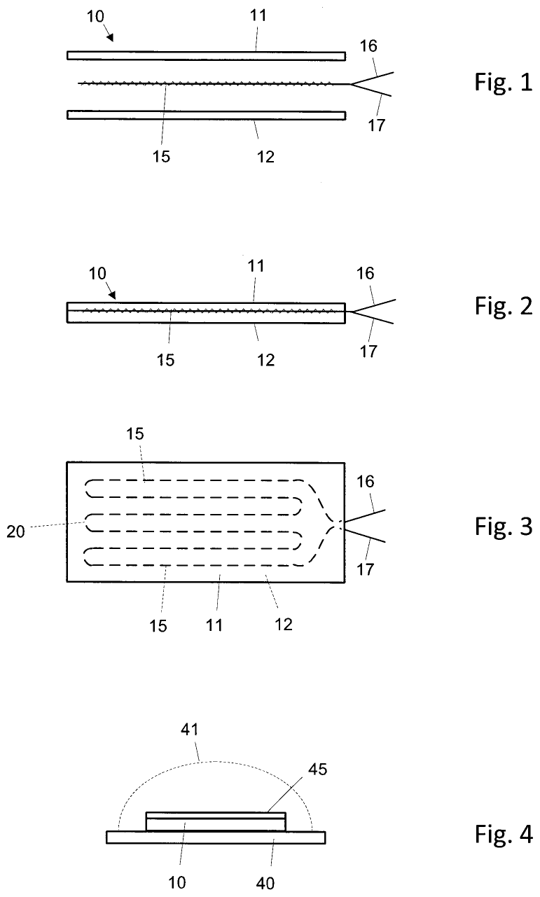

From the exploded side view shown in FIG. 1 the basic construction of the heating mat according to the invention can be inferred. The heating mat 10 shown comprises an upper flexible mat 11 made of, preferably reinforced, thermoplastic. Furthermore, the heating mat 10 comprises a lower flexible mat 12 made of, preferably reinforced, thermoplastic. The mats 11 and 12 may be similarly constructed, but variations may also occur when appropriate.

Between the mats 11 and 12 a heat emitting device 15 is arranged which is constructed by using an electric conductive wire having an electrically insulating surface layer. Also, electric conductive strips having an electrically insulting surface layer can be used.

According to the invention, the wires or strips are knitted or crocheted in any pattern and in any mesh size depending on for example desired heat performance, etc. Parallel wires or strips make it possible to have several electrical circuits which can be advantageous in some applications or at wire break/strip break, for example, in one electrical circuit, whereby a backup circuit is present. Of course, the knitted/crocheted device 15 can have different designs. It can be formed in one piece, for example, but can also have strip-like shape to permit desired laying pattern in the heating mat. The mesh size of the device can be varied, if desired, depending on the desired heating pattern and performance requirements.

As for the two thermoplastic mats 11, 12, these may be made of polyvinyl chloride (PVC), for example, but it should be understood that other thermoplastic variants are sometimes suitable to use, such as, for example, polyethylene (PE), ABS, PET, etc. Also, mixtures of different thermoplastic types can sometimes be advantageous to use in certain context. It should thus be understood that it is possible to vary to a large extent the choice of thermoplastic material. The thermoplastic mats have usually a suitable reinforcement and can sometimes be relatively thin.

The parts of the heating mat described above are combined to a heating mat 10, as shown in FIG. 2. In this connection, an edge reinforcement can be provided, if needed, which has both an aesthetic function and allows a later vacuum suction from the interior of the heating mat at a subsequent assembly phase.

FIG. 3 shows a possible placement of a heating device 15 produced according to the invention which is created by knitting or crocheting as previously described. The case shown has knitted or crocheted loops 20 which are placed sling-like and according to heat requirements. The external connecting wires of the heating device 15 are designated 16 and 17. The shape of the device can of course be varied as required.

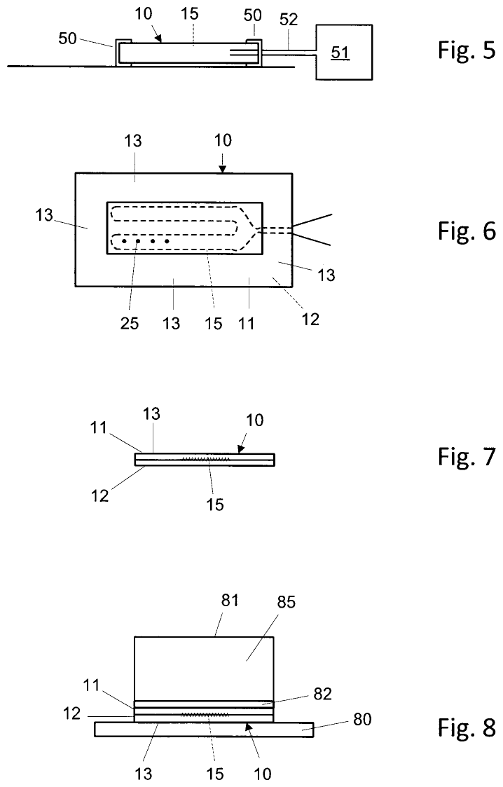

When assembling the heating mat several different possibilities are possible, and FIGS. 4 and 5 show two different examples.

In FIG. 4, the preassembled heating mat 10 is placed on a heatable plate 40 of metal, for example, and a vacuum bag 41 is activated for compression of the heating mat 10, and the heating mat is heated to required temperature for reliable internal adhesion, so that the mat becomes reliable self-assembled, i.e. the heating mat is integrally formed. In the example shown, a group of holes (not shown) has been arranged in the upper mat, for instance, and a spacer element 45 with necessary recesses, so that air and gas can be evacuated from the interior of the heating mat by means of the vacuum bag 41. The vacuum bag 41 ensures good compression of the heating mat 10 upon completion thereof. The heating must be monitored so that the exterior of the mats is not adversely affected at the same time as the internal adhesion operation is satisfactory.

FIG. 5 shows an alternative manufacturing method in which a tape 50 or equivalent is used for sealing the end portions of the heating mat 10. Heating and temperature control are normally carried out via the device 15. A vacuum suction device 51 is arranged as shown in the figure, its connecting pipe 52 being inserted against the device 15 where the connecting wires 16, 17 of the device leave the heating mat 10. If necessary, a heating plate can also be used in this embodiment.

It should be understood that the manufacturing methods according to FIGS. 4 and 5 can be combined, if needed.

FIGS. 6 and 7 show an embodiment of the heating mat 10 according to the invention having a circumferential collar portion 13 in which the two exterior mats 11, 12 of thermoplastic abut directly against each other in the collar portion 13 extending outside the heating device 15. This embodiment allows for example large freedom of choice with regard to the outer contour of the heating mat 10 with accompanying special adjustments.

The upper 11 of the two exterior mats 11, 12 is provided with a group of holes 25 which enable evacuation of air/gas from the inner portion of the heating mat 10. Some of the holes 25 are indicated in FIG. 6.

In FIG. 8, a manufacturing method for a heating mat 10 with a circumferential collar 13 is exemplified. A temperature adjustable heating table 80 is used upon which the heating mat is placed in a pre-assembled condition, after which a lid 81 comprising a spacer element 82 is placed on top of the heating mat 10. The lid 81 is so designed that the entire heating mat 10 is compressed by the lid and its spacer element 82. The lid comprises a vacuum suction device 85 which provides air and gas evacuation from the interior of the mat, so that the heating device 15 obtains maximum contact with the two thermoplastic mats 11, 12. The air and gas evacuation takes place via the holes 25 provided in the upper thermoplastic mat, and the spacer element 82 has necessary recesses for the suction action of the vacuum suction device 85. The heating in relation to the fusion into an assembled and finished heating mat takes place via the heating table 80. Also, the heating device can take part in the heating operation, if required.

Assembling time and temperature are of course dependent on the material selected.

Sometimes, it may be advantageous to use different thermoplastic materials in both thermoplastic mats.

The exterior surface of the thermoplastic mats can sometimes support a coating or foil for aesthetic or practical reasons, etc. Application can be done afterwards and sometimes even in advance.

It is to be understood that the heating pads according to the invention may have different sizes and shapes and may also be 3-dimensional. The heating mats are normally flexible and shapeable so that good adaptability exists for different field of applications.

In operation, the desired working temperature of the heating mat is controlled by controlling electric current dependent upon the measured resistance and temperature of the device. The maximum operating temperature of the heating mat is, of course, limited by the temperature resistance of the thermoplastic.

Of course, it should be understood that one or more heating devices could also be arranged in one and the same heating mat.

Below are some non-limiting examples of filed of applications of the heating mat according to the invention.

Prevention of ice-bounding of materials during transport and storage of materials.

Prevention or thawing of ice formation of roofing environments and associated dewatering details.

Stretchers or rescue stretcher in which the heating mat is divided into three different devices, for example, to be able to set different heating for different body parts, which for example is advantageous when a patient is heavily suffering from hypothermia.

Heating mattresses, thawing mats for frozen ground, providing underfloor heating, etc. Heating of balcony floors and terrace floors, etc.

Defrosting and/or retention of heat of mechanical components in outdoor environment, for example, during maintenance and repairs, for example. For example, it can be used as a heat generating vacuum bag during repairs, whereby the heat generation can be arranged variable and self-regulating.

The flexibility of the heating mat enables large possibilities for matching the design of the object to be heated.

It should be understood that the heating mat according to the invention has a very wide range of application in addition to what has been exemplified above and where there are great possibilities of variation.

Heat output and desired heat performance are regulated by desired power supply to present device.

When utilization of the heat output of the device of a heating mat, temperature control is carried out by measuring the resistance of the device and consequent current control. The same reasoning applies when the device takes part in heating together the heating mat according to the invention. To use constant voltage and varying current pulses for different heating needs is usually advantageous.

Additional temperature measurement on the external surface of the heating mat can sometimes be advantageous both in manufacturing and use.

Furthermore, it should be mentioned that the assembly effect of the heating mat can some time be increased by adhesive foils or equivalent.

It should be understood that the knitted or crocheted device can be designed in many different ways and effectively adapted to different needs regarding heating pattern.

Furthermore, it should be understood that the knitting or crocheting of the heat emitting device of the heating mat results in that the heating mat obtain a very good flexibility in all directions and also a very good resistance to point loads, for example, which is very advantageous. The heating mat withstands a large point load also on uneven ground without being destroyed.

Chemical-resistant thermoplastics can be used in troublesome environments. Also, high temperatures can be met by choosing the appropriate thermoplastic quality.

If necessary, the heating mat can be made very thin.

By varying the knitting or crocheting pattern within the heat emitting device, for example by varying mesh size, the heating pattern in the different zones of the heating mat can be varied.

Thus, the invention is not limited to what is shown and described, instead changes and modifications thereof are, of course, possible within the scope of protection of the appended claims.

1. Apparatus for a heating mat comprising two mats of thermoplastic between which mats at least one heat emitting device is arranged, wherein the device is produced by knitting or crocheting.

2. Apparatus according to claim 1, wherein the device comprises a conductive wire or a strip with an electrically insulating surface layer.

3. Apparatus according to claim 1, wherein the heating mat is arranged self-assembled.

4. Apparatus according to claim 1, wherein the heat emitting device of the mat has connecting wires for connection to an electrical power source.

5. Apparatus according to claim 1, wherein one of the thermoplastic mats has holes for evacuation of air/gas located inside the heating mat.

6. Apparatus according to claim 1, wherein the device is kept warm by an arrangement arranged for temperature monitoring by measuring resistance of the device, and that an arrangement is arranged for varying current pulse activities at constant voltage depending on the heating requirement of the device.

7. Apparatus according to claim 1, wherein meshes formed by knitting or crocheting have different sizes depending on the desired heating pattern within the heat emitting device.

8. Method for manufacturing a heating mat comprising two mats of thermoplastic between which mats at least one heat emitting device is arranged, comprising, after parts of the heating mat have been combined exerting compression of the heating mat during removal of air/gas present inside the heating mat, and during temperature monitoring, heating the heating mat by means of the device and/or at least an external heat source until the heating mat becomes self-assembled.

9-11. (canceled)
